(19) United States
(12) Patent Application Publication
(10) Pub. No.: US 2015/0167605 A1
(43) Pub. Date: Jun. 18, 2015

(54) FUEL LINE ASSEMBLY AND METHOD FOR OPERATING A FUEL LINE ASSEMBLY

(71) Applicant: TI AUTOMOTIVE (HEIDELBERG) GMBH, Heidelberg (DE)

(72) Inventor: Hans Jensen, Dettingen unter Teck (DE)

(21) Appl. No.: 14/573,886

(22) Filed: Dec. 17, 2014

(30) Foreign Application Priority Data
Dec. 17, 2013 (EP) 13 197 668.0

(51) Int. Cl. F02M 37/22; F02M 37/00

(52) U.S. Cl. CPC F02M 37/22; F02M 37/007; F02M 37/0017

(57) ABSTRACT

A fuel line assembly for motor vehicles, having two tubing sections and at least one filter device disposed between the two tubing sections. Fuel is supplied to the filter device via a first tubing section, and fuel is discharged from the filter device via a second tubing section, wherein the filter device has two functional states. In a first functional state of the filter device, the fuel supplied thereto is filtered by means of at least one filter medium in the filter device. After a blocking element in the filter device has been switched to a second functional state, the fuel flows through the filter device via at least one outlet channel, without filtering.

### CROSS-REFERENCE TO RELATED APPLICATIONS

This application claims priority pursuant to Title 35 U.S.C. §119(e) to European application for Patent No. 13 197 668.0, filed Dec. 17, 2013 for Fuel Line Assembly and Method for Operating a Fuel Line Assembly.

### BACKGROUND

The invention relates to a fuel line assembly for motor vehicles, having a plurality of tubing sections. The invention relates in particular to a fuel line assembly for diesel fuel, or for diesel engines, respectively. The invention furthermore relates to a method for operating a fuel line assembly.

Fuel line assemblies for motor vehicles are known in the field in various embodiments. During the manufacturing of the fuel line assembly, or the tubing sections of these assemblies, respectively, contaminant particles such as dust particles and the like are produced. These contaminant particles, or dust particles, respectively, can compromise, and in particular clog or block, the operation of the fuel line assembly, or the components connected to the motor vehicle allocated thereto, respectively, such as the nozzles, injectors, pumps or filter. For this reason, it is desirable to keep the fuel line assembly, or the tubing sections belonging thereto, free of such contaminants. In order to achieve this, the manufacturing of the fuel line assembly can be carried out under special conditions, in particular in clean rooms, and the manufactured components can be subjected to special cleaning measures. This is complex and expensive, however. Furthermore, frequently not all of the contaminants can be eliminated, or removed, however, such that during operation of the fuel line assembly, undesired disruptions may nevertheless occur.

Based on this, the invention addresses the technical problem of providing a fuel line assembly of the type specified above, in which the problems occurring due to soiling or contaminant particles can be effectively minimized or eliminated. The invention furthermore addresses the technical problem of providing a method for the operation of a fuel line assembly.

### SUMMARY OF THE INVENTION

In order to solve the technical problems, the invention teaches of a fuel line assembly for motor vehicles, in particular motor vehicles with diesel engines, wherein the fuel line assembly has at least two tubing sections and at least one filter device disposed between the two tubing sections, wherein a fluid medium, or fuel, respectively, can be, or is, supplied to the filter device via a first tubing section, and wherein the fluid medium, or fuel, respectively, can be, or is, discharged from the filter device via a second tubing section, wherein the filter device has at least two functional states, wherein, in the first functional state (filtering state) of the filter device, the fluid medium supplied via the first tubing section, or the fuel supplied via the first tubing section, respectively, can be, or is, filtered by means of at least one filter medium in the filter device, and wherein, after switching the filter device to a second functional state (flow-through state), the fluid medium, or the fuel passes through the filter device via at least one outlet channel, without filtering, or substantially without filtering, thereof.

Fundamentally, it is also within the scope of the invention that the fluid medium, or fuel, respectively, can also, or alternatively, be supplied, or is supplied, via the second tubing section, and in a first functional state (filtering state) of the filter device, can be, or is, filtered by means of the at least one filter medium in the filter device, and that after switching the filter device to a second functional state (flow-through state), the fluid medium, or the fuel, respectively, flows through the filter device via the at least one outlet channel, without filtering, or substantially without filtering thereof.—With the filter device, or with the filter medium of the filter device, respectively, contaminant particles present and carried along with the fluid medium, or with the fuel, respectively, can be filtered out. In this manner, the fuel line assembly can be cleaned of contaminant particles in the first functional state (filtering state).

In the scope of the invention, the term, “fluid medium” also refers to a fluid flushing medium, or a liquid flushing medium, differing from fuel, with which the fuel line assembly can be flushed in order to filter out contaminant particles prior to the installation in a motor vehicle. After installation in a motor vehicle, a flushing, or filtering, respectively, occurs, for practical purposes, by means of fuel—in particular during a test run of the engine in the motor vehicle. As a rule, however, a fluid flushing medium, or liquid flushing medium, respectively, can be used prior to the installation of the fuel line assembly in a motor vehicle. When fuel is referred to in the following, according to one embodiment of the invention, a fluid or liquid flushing medium differing from fuel is also meant.

It is within the scope of the invention that at least one inventive fuel line assembly is used in a fuel line comprising numerous tubing sections. Furthermore, it is within the scope of the invention that a fuel line assembly of this type is provided on at least both ends of a fuel line. For practical purposes, the filter device connects the tubing sections connected thereto directly with one another. It is within the scope of the invention that only one filter device is interconnected between two tubing sections. The first functional state of the filter device is also referred to here and in the following as the filtering state, and the second functional state of the filter device is also referred to here and in the following as the flow-though state. According to an established and proven embodiment, a filter device has only two functional states (filtering state and flow-through state).

The invention is based on the fact that with an inventive fuel line assembly, the problems arising due to contaminants in a fuel line can be simply and effectively minimized, or eliminated. In implementing an inventive fuel line assembly of this type, neither the mode of operation for the motor vehicle engine, nor the fuel supply system for the motor vehicle is negatively affected. As shall be explained in greater detail below, when a motor vehicle is put into operation, for practical purposes, the assembly is set to the second functional state, or the flow-through state. Thus, cleaning measures are realized in a simple and cost-effective manner in the scope of the invention, without resulting in a disadvantageous loss in pressure in the fuel supply when the motor vehicle is put into operation.

Fundamentally, various materials can be used as the filter medium of the filter device of the inventive fuel line assembly in the scope of the invention. According to one embodiment of the invention, nonwovens made of plastic fibers, for example, or multi-layered filter media comprising nonwovens and paper, can be used as the filter medium. Papers made of cellulose fibers impregnated with special resins are also suited for use as the filter medium for the filter device.

For practical purposes, the tubing sections have a circular cross-section, or a substantially circular cross-section, respectively. It is recommended that the tubing sections of the fuel line assembly consist of plastic, or substantially consist of plastic, respectively. It is preferred that the tubing sections be produced by means of extrusion or coextrusion. According to one embodiment, the filter device, or the filter housing of the filter device, also consists of plastic, or substantially consists of plastic, respectively.

It is within the scope of the invention that the inventive fuel line assembly is in the first filtering state, or is switched to the first filtering state, respectively, after it has been manufactured. It is also within the scope of the invention that the fuel line assembly remains in this first functional state (filtering state) during and after the installation in a motor vehicle. It is recommended that the first functional state (filtering state) remains set during at least a test run of engine for the motor vehicle. Contaminants, or contaminant particles can then be effectively removed from the fuel line assembly, in that the fuel flows though the filter medium in the filter device. It is within the scope of the invention that the second functional state (flow-through state) is first set, or will be set, after the motor vehicle has been put into operation, or after the motor vehicle has been put into operation in the finalized state.

For practical purposes, the outlet channel for the filter device is closed with at least one blocking element in the first functional state (filtering state). Preferably, the outlet channel is opened after/during the switching from the first functional state (filtering state) to the second functional state (flow-through state), or, respectively, the outlet channel is opened by means of the blocking element. It is recommended that the blocking element is disposed at the entry, or start, respectively, of the outlet channel with respect to the direction of flow. The blocking element can be, in particular, a slide valve, which for practical purposes is integrated in the control and/or regulating system of the motor vehicle. According to a particularly preferred embodiment, the outlet channel has the same flow cross-section area, or substantially the same flow cross-section area, as the first tubing section and/or the second tubing section. By this means it is ensured that in the second functional state (flow-through state), the fluid medium, or the fuel, respectively, is conveyed through the fuel line assembly without pressure loss, or substantially without pressure loss, respectively. For practical purposes, the outlet channel, or the interior of the outlet channel, respectively, with respect to its size and/or shape, corresponds to the first tubing section and/or the second tubing section, or, respectively, the interior of the first tubing section and/or the second tubing section. It is within the scope of the invention that the outlet channel is aligned with the first tubing section and/or the second tubing section.

According to a preferred embodiment of the invention, the filter medium in the filter device is disposed adjacent to the flow-through channel, or directly adjacent to the flow-through channel, respectively. Preferably, the filter medium is in a fluid connection, or in a direct fluid connection, respectively, with the outlet channel thereby. Thus, in the first functional state (filtering state), the fluid medium, or the fuel, respectively, flows first through the filter medium in the filter device, and subsequently through the flow-through channel, out of the filter device. According to a particularly preferred embodiment of the invention, the filter medium of the filter device surrounds the outlet channel, over at least a portion of its circumference, preferably a majority of its circumference, and very preferably, the entire circumference of the outlet channel. The outlet channel is disposed, for practical purposes, in the middle, or center, of the filter device, or the filter housing in the filter device. Preferably, the outlet channel and filter medium in the filter device, or in the filter housing in the filter device, respectively, are disposed coaxial to one another.

It is within the scope of the invention that in the first functional state (filter state), the fluid medium supplied via the first tubing section, or the fuel supplied via the first tubing section, respectively, flows through the filter medium in the filter device in an outlet section of the outlet channel, or directly in an outlet section of the outlet channel, respectively, and from there in the second tubing section. Thus, it is within the scope of the invention that the outlet channel is also active in the first functional state (filtering state), or that the fluid medium/fuel flows through it.

A method for the operation of a fuel line assembly is also the subject matter of the invention, wherein the fuel line assembly has at least one filter device with at least one intake end and with at least one discharge end, wherein the intake end is connected to a first tubing section, and the discharge end is connected to a second tubing section, wherein, in a first functional state (filtering state) of the filter device, a fluid medium—in particular liquid fuel—is conducted through the fuel line assembly, and the fluid medium/fuel flows through at least one filter medium in the filter device, such that contaminant particles contained in the fuel line assembly, in particular contaminant particles from the manufacturing process for the fuel line assembly, are filtered out by the filter medium in the filter device.

It is within the scope of the invention that, after the fuel line assembly has been manufactured, it is/will be set to the first functional state (filtering state). It is furthermore within the scope of the invention that the inventive fuel line assembly is installed in a motor vehicle, and then, preferably, remains set in the first functional state (filtering state) until the motor vehicle has been put into operation, or has been put into operation in the finalized state. Furthermore, it is within the scope of the invention that at least after the motor vehicle has been put into operation, or has been put into operation in the finalized state, the filter device is set to the second functional state (flow-through state), in which flow-through state, fuel flows through the filter device without filtering, or substantially without filtering, and particularly, without a pressure loss connected therewith. In this second functional state, the filtering function of the filter device is basically inactive. For practical purposes, the first functional state (filtering state) remains set at least during a test run of the motor vehicle engine, or the motor vehicle, respectively. The second functional state (flow-through state) is first set thereafter—meaning when the motor vehicle has been put into operation in the finalized state—for practical purposes. It is recommended that the second functional state (flow-through state) then remains set permanently.

The invention is based on the idea that contaminants in the fuel line assembly can be simply and effective removed with the inventive fuel line assembly, and with the inventive method, prior to the motor vehicle being put into operation. This applies, in particular, for contaminant particles from the manufacturing process for the fuel line assembly. In this respect, an effective protection from contamination is obtained with the invention. In comparison with known measures, an impairment of vehicle components—such as nozzles, injectors, filters, pumps and suchlike—by contaminants can be effectively avoided with the implementation of the inventive measures. It should be emphasized here that the inventive fuel line assembly and the inventive method can be implemented with simple, less complex, and cost-effective measures.

### DESCRIPTION OF THE DRAWINGS

The invention shall be explained below based on drawing depicting only one embodiment example. Shown are, in schematic depictions:

FIG. 1 is a section cut through an inventive fuel line assembly in a first functional state (filtering state),

FIG. 2 is the subject matter of FIG. 1, in a second functional state (flow-through state), and

FIG. 3 is a cut at line A-A through the subject matter of FIG. 1.

### DETAILED DESCRIPTION OF ILLUSTRATED EMBODIMENT

The figures show an inventive fuel line assembly for motor vehicles, which are not depicted in greater detail, in particular motor vehicles with diesel engines. The fuel line assembly has two tubing sections 1, 2 and one filter device 3 disposed between the tubing sections 1, 2. A first tubing section 1 is connected to an intake end 4 of the filter device 3, and a second tubing section is connected to a discharge end 5 of the filter device. The tubing sections 1, 2 consist, for practical purposes, of plastic, and preferably have a circular cross-section.

The filter device 3 that connects the tubing sections 1, 2 preferably, and in the embodiment, has a cylindrical filter housing 6.

It is recommended that, and in the embodiment example, an outlet channel 7 for the fluid medium, or for the fuel, respectively, runs through the middle, or center, respectively, of the filter housing 6. Preferably, and in the embodiment example, the outlet channel 7 has the same flow cross-section area as the first tubing section 1 and the second tubing section 2, and the outlet channel is preferably aligned with the tubing sections 1, 2. It is recommended that, and in the embodiment example, a filter medium in the filter device 3 surrounds the circumference of the outlet channel 7. Thus, according to preferred embodiments, and in the embodiment example, the outlet channel 7 and filter medium 8 are disposed coaxial to one another. It is within the scope of the invention that the filter medium 8 is in a fluid connection with the outlet channel 7, this being in the region of the outlet section 9 of the outlet channel 7.

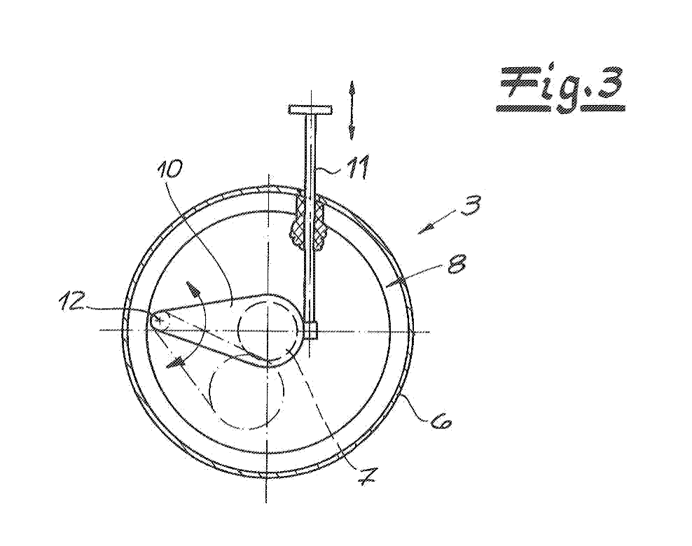

A blocking element 10, designed as a slide valve, is provided in the embodiment example, with which the outlet channel 7 can be blocked at its intake. For practical purposes, and in the embodiment example, a control element is connected to the blocking element 10. Preferably, and in the embodiment example, the slide valve, or blocking element 10, respectively, can be pivoted about a pivot axis 12 by means of the control element, and can be transferred from a closed position to an open position, and vice versa (see, in particular, FIG. 3). After the installation of the fuel line assembly in a motor vehicle, the control element 11, or the blocking element 10, respectively, can be a component of a control and/or regulating device for a motor vehicle, and for practical purposes, can be actuated by remote control.

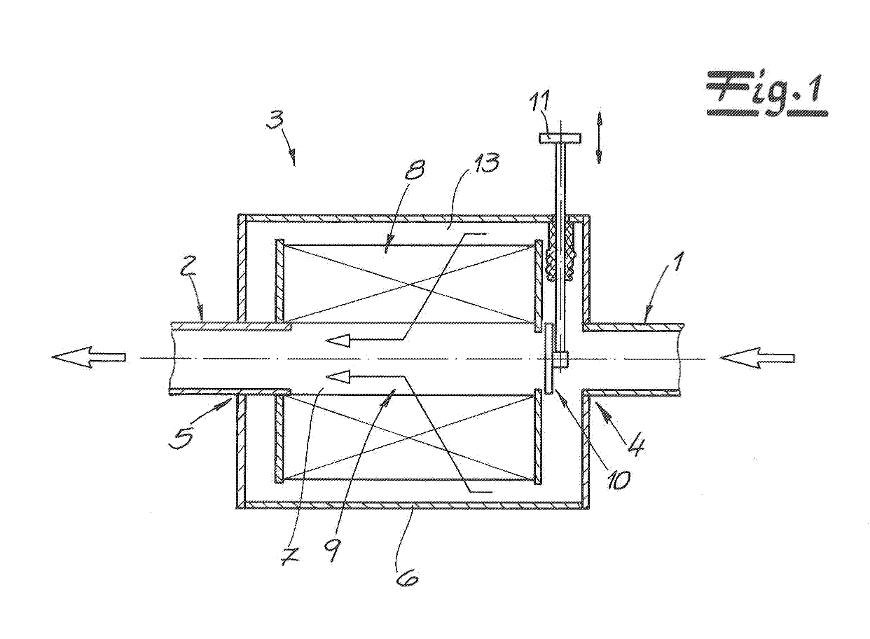

After the inventive fuel line assembly has been manufactured, initially the first functional state (filtering state) depicted in FIG. 1 is set. This is also the case, for practical purposes, after the installation of the fuel line assembly in a motor vehicle, and prior to the motor vehicle being put in operation, or put in operation in the finalized state. In this first functional state (filtering state), the outlet channel 7 of the filter device 2 is blocked by means of the blocking element 10. Fluid medium, or fuel, flows via the first tubing section 1 through the intake end 4 into the filter device 3. Preferably, and in the embodiment example, the fluid medium, or the fuel, respectively, then flows radially outward in an outer annular region 13 of the filter housing 6, and from there through the filter medium 8, into the outlet section 9 of the outlet channel 7. Subsequently, the fluid medium, or the fuel, respectively, exits the filter device through the discharge end 5, and then flows through the second tubing section 2. In this first functional state (filtering state), contaminant particles can be effectively filtered out of the fluid medium, or fuel, respectively. It is within the scope of the invention that this first functional state is set during a test run of the motor vehicle engine, and that the fuel is then filtered by means of the filter device 3, before the motor vehicle is put into operation in the finalized state.

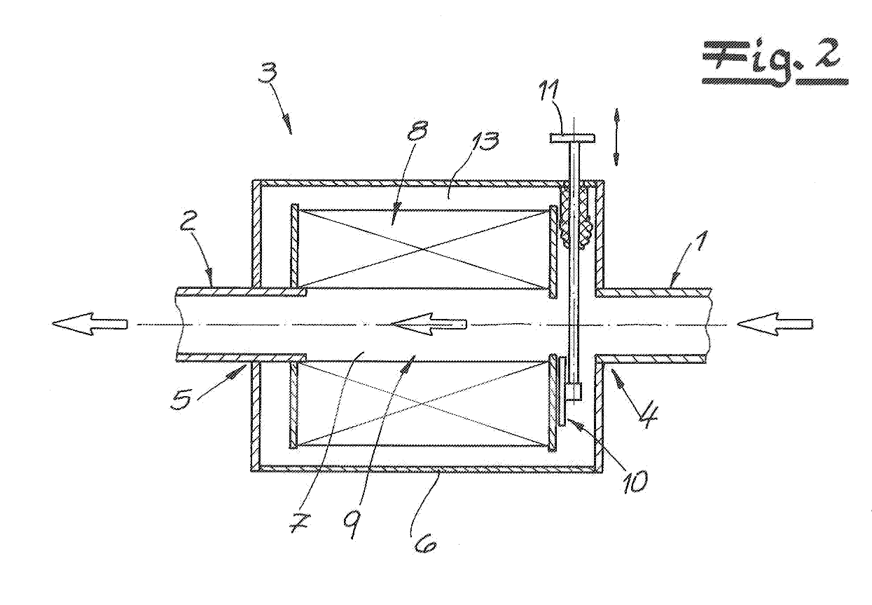

Prior to, or when the motor vehicle is put into operation, the second functional state (flow-through state) is then set, which is depicted in FIG. 2. In order to set this second functional state, the blocking element 10 is transferred with the control element 11 into the open position. The fluid medium, or fuel, respectively, can then flow from the first tubing section 1 via the intake end 4 directly through the outlet channel 7 to the discharge end 5, or to the second tubing section 2, respectively. This flow-through then occurs without filtering and without pressure loss, and the filter device 3 is basically inactive in this state. It is within the scope of the invention that this second functional state (flow-through state) is permanently set, or remains set, during the operation of a motor vehicle. It is furthermore within the scope of the invention that the filtering of contaminant particles from the fluid medium, or from the fuel, respectively, occurs only before the motor vehicle is put into operation.

With the inventive fuel line assembly, contaminants can thus be effectively and simply removed from the assembly, such that when the motor vehicle is in operation, the functioning of the fuel supply is not compromised in any sense—in particular by a pressure loss or the like. It should be emphasized here that the inventive measures can be implemented easily and cost-effectively.

Variations and modification of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the invention and will enable others skilled in the art to make and utilize the invention. The claims are to be construed to include alternative embodiments to the extent permitted by the prior art.

1. A fuel line assembly for motor vehicles, in particular for motor vehicles with diesel engines, having two tubing sections (1, 2) and at least one filter device (3) disposed between the two tubing sections (1, 2), wherein a fluid medium, or fuel, respectively, can be supplied to the filter device (3) via a first tubing section (1), and wherein the fluid medium, or fuel, respectively, can be discharged from the filter device (3) via a second tubing section (2), wherein the filter device (3) has at least two functional states, wherein, in a first functional state of the filter device (3), the fluid medium, or fuel, respectively, supplied thereto can be filtered by means of at least one filter medium (8) in the filter device (3), and wherein, after switching the filter device (3) to a second functional state, the fluid medium, or fuel, respectively, flows through the filter device (3) via at least one outlet channel (7), without being filtered, or substantially without being filtered, respectively.

2. The fuel line assembly according to claim 1, wherein the tubing sections (1, 2) consist of plastic, or substantially consist of plastic, respectively, and are preferably manufactured by means of extrusion, or coextrusion, respectively.

3. The fuel line assembly according to claim 1 wherein the filter device includes a blocking device wherein the outlet channel (7) is closed off in the first functional state with at least one shutoff element, and wherein after/during the switching the blocking device from the first functional state to the second functional state, the outlet channel (7) is open.

4. The fuel line assembly according to claim 1 wherein the outlet channel (7) has the same flow cross-section area, or substantially the same flow cross-section area, respectively, as the first tubing section (1) and/or the second tubing section (2).

5. The fuel line assembly according to claim 1 wherein the outlet channel (7) is aligned with the first tubing section (1) and/or the second tubing section (2).

6. The fuel line assembly according to claim 1 wherein the filter medium in the filter device (3) is disposed adjacent to the outlet channel (7), and is preferably in a fluid connection, or directly in a fluid connection, respectively, with the outlet channel (7).

7. The fuel line assembly according to claim 1 wherein the filter medium (8) in the filter device (3) surrounds the outlet channel (7) over at least a portion of its circumference, preferably over the majority of its circumference, and particularly preferably over its entire circumference.

8. The fuel line assembly according to claim 1 wherein, in the first functional state, the fluid medium/fuel supplied via the first tubing section (1) flows through the filter medium (8) in the filter device (3) into an outlet section (9) of the outlet channel (7), and from there into the second tubing section (2).

9. A method for operating a fuel line assembly, wherein the fuel line assembly has two tubing sections (1, 2) and at least one filter device (3) disposed between the two tubing sections with at least one intake end (4) and with at least one discharge end (5), wherein the intake end (4) is connected to the first tubing section (1) and the discharge end (5) is connected to the second tubing section (2), and the filter device includes a blocking device for setting said filter device in a first functional state or a second functional state and where in the method comprising setting a first functional state of the filter device (3), conducting a fluid medium—in particular liquid fuel—through the fuel line assembly, and the fluid medium/fuel flows though at least one filter medium (8) in the filter device, such that contaminant particles contained in the fuel line assembly, in particular contaminant particles arising from the manufacturing process for the fuel line assembly, are filtered out by means of the filter medium (8).

10. The method according to claim 9, wherein the first functional state is set after the fuel line assembly has been manufactured, wherein the fuel line assembly is installed in a motor vehicle, and wherein at least after the motor vehicle has been put into operation setting the second functional state, whereby the fluid medium, or the fuel, respectively, flows through the filter device (3) without being filtered, or substantially without being filtered, respectively.

11. The method according to claim 9 wherein the first functional state is set during a test drive of the motor vehicle, or the motor vehicle engine, respectively.

12. The method according to claim 9 wherein the second functional state is permanently set, or is substantially permanently set, after the motor vehicle has been put into operation in the finalized state.

13. A fuel line for a motor vehicle, in particular for a motor vehicle with a diesel engine, wherein at least one fuel line assembly according to claim 1 is provided on each of two ends of the fuel line.
